(19) United States
(12) Patent Application Publication
(10) Pub. No.: US 2025/0203298 A1
(43) Pub. Date: Jun. 19, 2025

(54) Acoustic Assembly Detection in Hearing Aid

(71) Applicant: Bose Corporation, Framingham, MA (US)

(72) Inventor: Yaniv Eliezer Kaufman, Victoria (AU)

(21) Appl. No.: 18/537,981

(22) Filed: Dec. 13, 2023

(51) Int. Cl. H04R 25/00; H04R 9/06; H04R 11/02

(52) U.S. Cl. CPC H04R 25/505; H04R 9/06; H04R 11/02; H04R 25/305; H04R 25/609; H04R 2225/0216

(57) ABSTRACT

Aspects include a hearing aid with a control module configured to detect connection with distinct driver modules. The hearing aid is configured to adjust one or more settings in response to detecting connection with one of the driver modules.

### TECHNICAL FIELD

This disclosure relates to an acoustic assemblies such as hearing aid assemblies. More particularly, the disclosure relates to acoustic assemblies with driver modules.

### BACKGROUND

Certain acoustic assemblies such as hearing aids or other audio devices can include modular components enabling distinct power outputs, fits, acoustic performance features and/or other sensors. However, conventional assemblies do not effectively detect which modular components are connected in order to tailor audio signal processing.

### SUMMARY

Aspects include a hearing aid with a control module configured to detect connection with distinct driver modules. The hearing aid is configured to adjust one or more settings in response to detecting connection with one of the driver modules.

Various implementations include a hearing aid, comprising: a control module comprising: electronics for communicating with a first driver module and a second driver module; and an interconnect configured to interchangeably connect with the first driver module and the second driver module, where the electronics are configured to measure a physical property of a connected one of the first driver module or the second driver module to determine which of the first driver module or the second driver module is connected, and, in response to the determination, adjust one or more settings. In certain cases, the settings relate to processing an audio signal.

Various additional implementations include a hearing aid comprising: a first receiver-in-canal (RIC) module comprising a first driver module; a behind-the-ear (BTE) module comprising electronics for communicating with the first RIC module; and an interconnect for connecting the first RIC module and the BTE module, where the interconnect is configured to interchangeably connect with the first RIC module and a second RIC module having a second driver module, and where the electronics are configured to measure a physical property of a connected one of the first RIC module or the second RIC module to determine which of the first RIC module or the second RIC module is connected, and, in response to the determination, adjust one or more settings.

Various further implementations include an acoustic assembly, comprising: a first driver module; a control module comprising electronics for communicating with the first driver module; and an interconnect for connecting the first driver module and the control module, where the interconnect is configured to interchangeably connect with the first driver module and a second driver module, where the first driver module and the second driver module differ in one or more characteristics, and where the electronics are configured to measure a physical property of a connected one of the first driver module or the second driver module to determine which of the first driver module or the second driver module is connected, and, in response to the determination, adjust one or more settings.

All examples and features mentioned below can be combined in any technically possible way.

In certain cases, the first driver module and the second driver module differ in one or more characteristics.

In particular aspects, the one or more characteristics include distinct driver types.

In certain cases, the electronics provide a processed audio signal to the connected one of the first driver module or the second driver module. In a particular example, the control module includes a behind-the-ear (BTE) controller.

In some aspects, the first driver module includes first wiring for coupling the first driver module to the interconnect and the second driver module includes second wiring for coupling the second driver module to the interconnect.

In particular implementations, the electronics are configured to measure a physical property of the connected one of the driver modules via the corresponding wiring.

In certain cases, the electronics in the control module detect a first voltage when the first driver module is connected with the interconnect and a second voltage when the second driver module is connected with the interconnect.

In some implementations, the first driver module and the second driver module are in-ear driver modules.

In particular aspects, the first driver module and the second driver module include receiver-in-canal (RIC) modules. In particular examples, the first driver module and second driver module have distinct acoustic displacement limits. In certain cases, the distinct acoustic displacement limits are related to distinct driver sizes and/or distinct sizes of acoustic cavity in the respective driver module.

In certain implementations, the control module includes a behind-the-ear (BTE) module.

In particular cases, when the second driver module is connected with the interconnect, at least a portion of wiring in the second driver module is shorted.

In certain implementations, when the second driver module is connected with the interconnect, at least one microphone wire is shorted to a microphone power wire.

In some aspects, the first driver module includes a moving coil driver, where the first driver module is capable of providing acoustic noise reduction (ANR) functionality and enables full bandwidth audio output, and where the second acoustic assembly include a balanced armature (BA) driver.

In certain cases, the electronics measure at least one of a voltage response or a frequency response of the connected first RIC module or the second RIC module to determine which of the first RIC module or the second RIC module is connected.

In some aspects, the first RIC module is capable of providing acoustic noise reduction (ANR) functionality and enables full bandwidth audio output, and the second RIC assembly includes a balanced armature (BA) driver.

In some cases, a hearing aid includes the acoustic assembly.

In certain aspects, an automobile audio system includes the acoustic assembly.

In particular cases, a home audio system includes the acoustic assembly.

Two or more features described in this disclosure, including those described in this summary section, may be combined to form implementations not specifically described herein.

The details of one or more implementations are set forth in the accompanying drawings and the description below. Other features, objects and benefits will be apparent from the description and drawings, and from the claims.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples, and are incorporated in and constitute a part of this specification, but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1 is a perspective view of an example hearing aid according to various implementations.

FIG. 2 is a schematic view illustrating example electronics included in a hearing aid with a first driver module according to various implementations.

FIG. 3 shows example electronics in a control module of a hearing aid according to various implementations.

FIG. 4 is a schematic view illustrating example electronics included in a hearing aid with a second driver module according to various implementations.

FIG. 5 is a schematic view illustrating example electronics included in a hearing aid with a third driver module according to various implementations.

FIG. 6 is an example wiring diagram showing connections between a driver module and a control module according to various implementations.

FIG. 7 is an example wiring diagram showing connections between another driver module and a control module according to various implementations.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

Various disclosed implementations include acoustic assemblies that include modular components. For example, a hearing aid or other acoustic assembly can include a control module with an interconnect that is configured to interchangeably connect with distinct driver modules. The control module can be configured to measure a physical property of one of the connected driver modules to differentiate between those modules and adjust one or more settings at the audio device, e.g., for audio signal processing, tuning, device functionality, etc. The disclosed implementations can enhance acoustic performance in an audio device such as a hearing aid or other audio device, e.g., in a vehicle audio system and/or a home audio system. Further, disclosed implementations can be beneficially deployed in additional audio systems that have modular components such as driver modules, e.g., in automobile audio systems, home audio systems, etc.

Certain conventional hearing aids (or, hearing assist devices) provide a number of different earpieces with receivers having different output power specifications. Further, earpieces are commonly provided with interconnecting members of different lengths, e.g., several distinct lengths, to suit the individual anatomy of the intended user. As such, a hearing aid may be sold or otherwise provided to a user with a dozen or more possible combinations of receiver type (e.g., driver module type) and interconnect length. Conventional hearing aid manufacturers address this issue by embedding a code or other readable identifier in the receiver such that the controller can read the identifier and appropriately tailor the acoustic signal. Such conventional approaches are described in U.S. Pat. Nos. 10,028,066 and 10,051,392, each of which is incorporated herein by reference in its entirety. In contrast to these conventional approaches, various implementations include an acoustic assembly such as a hearing aid that includes control module configured to measure a physical property of a connected driver module to determine which of a plurality of driver modules is connected.

Examples of the acoustic assemblies (e.g., hearing aids) described herein are not limited in application to the details of construction and the arrangement of components set forth in the following description or illustrated in the accompanying drawings. The acoustic assemblies are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

Also, the phraseology and terminology used herein is for the purpose of description and should not be regarded as limiting. Any references to examples, components, elements, acts, or functions of the devices herein referred to in the singular may also embrace embodiments including a plurality, and any references in plural to any example, component, element, act, or function herein may also embrace examples including only a singularity. Accordingly, references in the singular or plural form are not intended to limit the presently disclosed devices, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Commonly labeled components in the FIGURES are considered to be substantially equivalent components for the purposes of illustration, and redundant discussion of those components is omitted for clarity.

Various disclosed implementations relate to hearing aids (or, hearing aids) and other modular acoustic assemblies, certain aspects of which are described in U.S. Pat. No. 11,234,085 (“Earpieces and Related Articles and Devices” issued Jan. 25, 2022) and U.S. patent application Ser. No. 17/446,896 (“Hearing Assistance Devices and Methods of Generating a Resonance Within a Hearing Assistance Device” filed Sep. 3, 2021), each of which is entirely incorporated by reference herein.

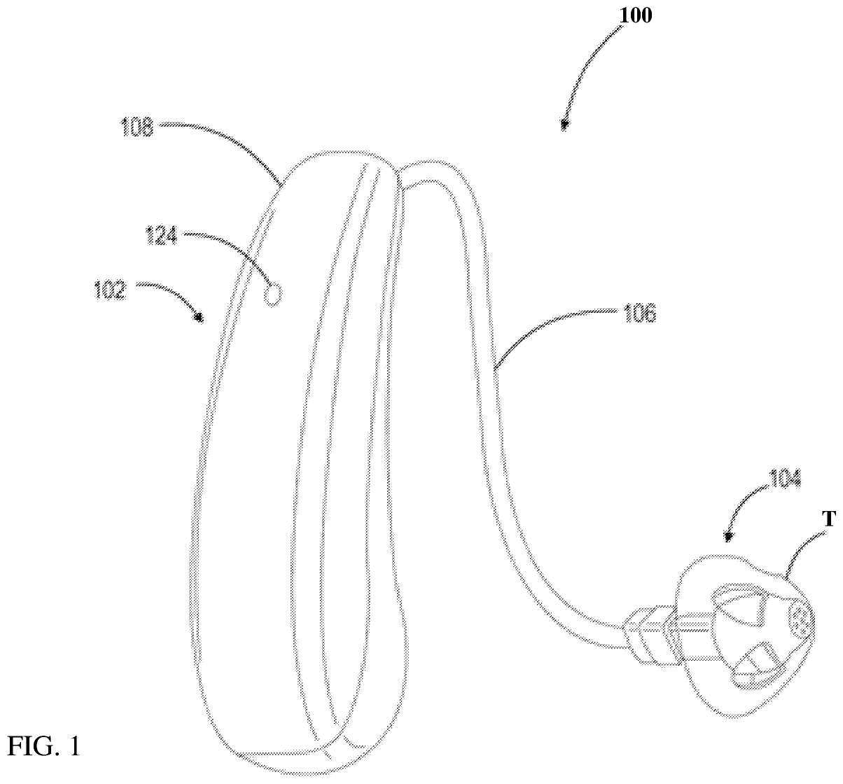

The term “hearing assistance device” or “hearing aid” as used in this disclosure, in addition to including its ordinary meaning or its meaning known to those skilled in the art, is intended to mean a device that fits around, on, in, or near an ear (including open-ear audio devices worn on the head or shoulders of a user) and that radiates acoustic energy into or towards the ear. A hearing assistance device includes an acoustic driver to transduce audio signals to acoustic energy. The acoustic driver can be housed in an earcup, earbud, or other portion of the hearing assistance device that sits within the user's ear canal during operation. While some of the figures and descriptions following can show a single hearing assistance device, a pair of hearing assistance devices can be provided, each having a respective portion that sits within the user's ear canal. Additionally, each hearing assistance device can be connected mechanically to another hearing assistance device or headphone, for example by a headband and/or by leads that conduct audio signals to an acoustic driver in the hearing assistance device or headphone. Further, as described herein, hearing assistance devices can include components for wirelessly receiving audio signals. A hearing assistance device can also include components of an active noise reduction (ANR) system. Hearing assistance devices can also include other functionality such as a microphone so that they can function as a headset. While FIG. 1 shows and example of a behind-the-ear form factor, in other examples the hearing assistance device can be an on-ear, around-ear, in-ear, or near-ear headset.

FIG. 1 is a front perspective view of a hearing aid (or, hearing assistance device) 100 according to the present disclosure. Hearing aid 100 includes a control module 102 and a first driver module 104. In a particular example, the control module 102 is a behind-the-ear (BTE) module and the first driver module 104 is a first receiver-in-canal (RIC) module. During operation of hearing aid 100, the control module (or, behind-the-ear portion) 102 (hereinafter referred to as “BTE portion 102”) is configured to secure to or mount behind a user's ear, while the first driver module (or RIC portion) 104 is configured to sit within a user's ear canal. BTE portion 102 is communicably coupled or in electrical communication with first driver module 104 via one or more wires 106. As discussed herein, audio signals and/or electrical signals processed or utilized by BTE portion 102 or first driver module 104 are transported via the one or more wires (or, interconnects) 106 in the generation of audible acoustic energy proximate the user's ear canal. In certain implementations, the wire(s) 106 is referred to as an interconnect, and it is understood that any configuration capable of physically connecting BTE portion 102 and first driver module 104 can be used in accordance with various disclosed implementations. In certain implementations, the interconnect 106 is integral with the BTE portion 102, but can be removably (or, modularly) coupled with the first driver module 104.

As illustrated in this example, first driver module 104 includes a deformable tip T configured to engage with at least a portion of the user's ear or ear canal. Although illustrated as an open deformable tip, e.g., a deformable tip with one or more holes, it should be appreciated that tip T can be a closed tip, e.g., where tip T includes no holes and the surface of tip T is configured to engaged with the user's ear canal so as to form an acoustic seal against and with the user's ear canal. In some examples, tip T is arranged on a nozzle of a second housing of the first driver module 104. Throughout the present disclosure, reference is made to a hearing aid 100; however it should be appreciated that the principles discussed herein, i.e., modular components and related control approaches, can be implemented in other audio devices, e.g., earbuds, headsets, headphones, sport headphones, audio eyeglass form factor devices, whether they are wired or wireless. Further, such principles can be applied to other audio systems with modular components, e.g., vehicle (e.g., automobile) audio systems and/or home audio systems.

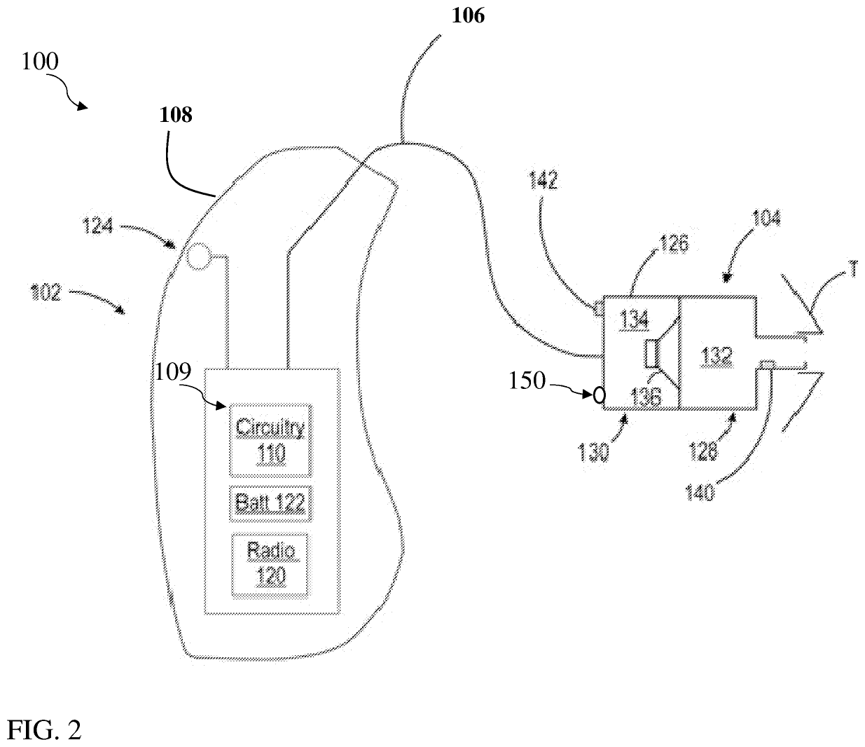

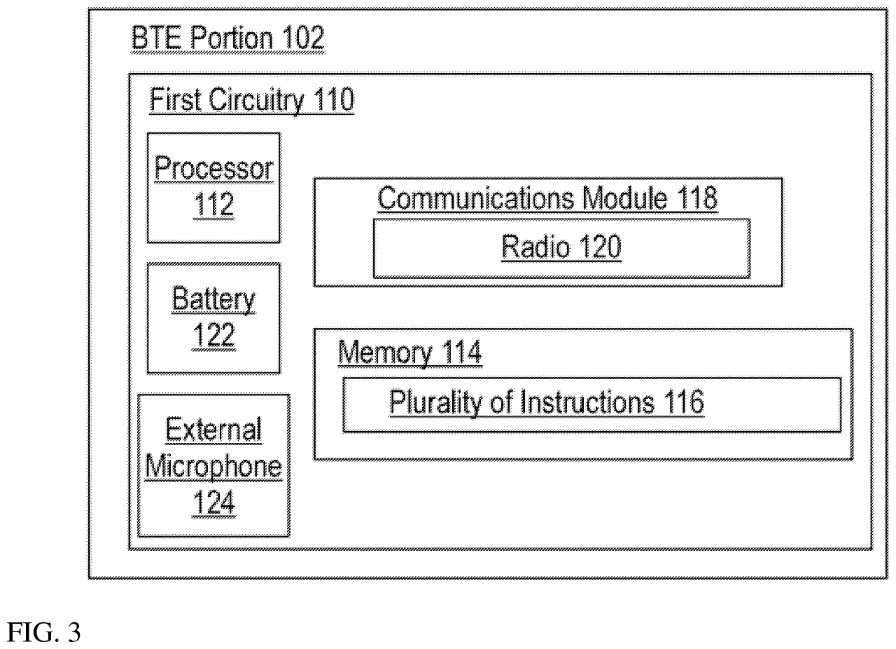

FIG. 2 is a schematic view of hearing aid 100 according to various implementations. FIG. 3 illustrates a schematic view of the internal components of BTE portion 102 according to the present disclosure. As illustrated schematically in FIGS. 1-3, BTE portion 102 includes a first housing 108 (FIG. 1) configured to at least partially enclose electronics 109 including first circuitry 110. First circuitry 110 includes a processor 112 and a memory 114 configured to execute and store, respectively, a plurality of non-transitory computer-readable instructions 116, to perform the various functions of BTE portion 102 as will be described herein. First circuitry 110 can also include a communications module 118 configured to send and/or receive data, e.g., data used to generate the acoustic energy discussed below. In some examples, communications module 118 is capable of sending and receiving wired or wireless data. To that end, communications module 118 can include at least one radio or antenna, e.g., radio 120, capable of sending and receiving wireless data. In some examples, communications module 118 can include, in addition to at least one radio (e.g., radio 120), some form of automated gain control (AGC), a modulator and/or demodulator, and potentially a discrete processor for bit-processing that are electrically connected to processor 112 and memory 114 to aid in sending and/or receiving wired or wireless data. In some examples, as illustrated in FIGS. 2 and 3, electronics 109 including first circuitry 110 can include or otherwise be housed with a battery 122 or other power source and an external microphone 124. Battery 122 is configured to store electrical energy sufficient to provided power to BTE portion 102 as well as first driver module 104 (and additional, modular driver modules described herein) via one or more interconnects (e.g., wires) 106. Although illustrated and described as a simple battery, it should be appreciated that battery 122 can include any storable power source, e.g., a lithium ion battery, capacitor, or supercapacitor. External microphone 124 is positioned within first housing 108 and configured to receive acoustic energy from outside of first housing 108 of BTE portion 102 coming from the environment surrounding the user. External microphone 124 can also be used in the active noise reduction or active noise cancellation functionality of hearing aid 100, as discussed herein. During use of the hearing aid 100, electronics 109 are configured to provide a processed audio signal to the connected driver module, e.g., first driver module 104 or another driver module as described herein. As used herein, the term “driver module” can refer to a module that includes an acoustic driver (or, transducer) and is capable of providing an audio output. In some examples, the driver module is one of a number of driver modules (e.g., two, three, four, five, or more modules) capable of interchangeably connecting with a control module, e.g., in a BTE portion 102. It is understood that distinct driver modules can differ in one or more characteristics, and need not necessarily differ in the size or characteristics of the acoustic driver therein. That is, distinct driver modules may differ in other characteristics such as size, sensor capabilities and/or the presence of additional sensors, and/or connectors. It is also understood that distinct driver modules can differ in acoustic driver size, as well as output (e.g., acoustic volume displacement) capabilities.

FIG. 2 also illustrates a schematic view of first driver module 104 and the internal components of first driver module 104. As illustrated, first driver module 104 includes a RIC housing 126 configured to at least partially encompass a plurality of components arranged to receive data from BTE portion 102 via one or more interconnects (wires) 106 and generate audible acoustic energy within the user's ear canal. In the example depicted in FIG. 2, RIC housing 126 includes a front portion 128 and a rear portion 130. Front portion 128 is intended to include portions of RIC housing 126 configured to contact and engage with the user's ear canal during operation of hearing aid 100, e.g., tip T of a nozzle. Front portion 128 can also include a front cavity 132 arranged within RIC housing 126 and front portion 128 of first driver module 104. Rear portion 130 is intended to include the internal and external portions of RIC housing 126 diametrically opposed to front portion 128, and includes a rear cavity 134 arranged within RIC housing 126 and rear portion 130. In this example first driver module 104, an acoustic driver 136 is positioned between front portion 128 and rear portion 130. In certain cases, acoustic driver 136 is an electrodynamic driver, e.g., an electrodynamic coil driver. As such, acoustic driver 136 is electrically connected to first circuitry 110 of BTE portion 102 via the one or more wires 106 and is arranged to receive electrical signals from first circuitry 110 and generate audible acoustic energy within RIC housing 126. In certain examples, the first driver module 104 can also include a feedback microphone 140 and a feedforward microphone 142, which can enable active noise reduction (ANR) functions. It is understood, however, that microphones 140, 142 and/or ANR functions are optional in various implementations. In certain cases, first circuitry 110 includes an ANR device including a configurable digital signal processor (DSP), which can be used for implementing various signal flow topologies and filter configurations. Examples of such DSPs are described in U.S. Pat. Nos. 10,580,398, 8,073,150 and 8,073,151, which are incorporated herein by reference in their entirety.

In still further implementations, additional sensors (or alternative sensors) 150 can be located at one of the modules, e.g., first driver module 104, and configured to provide a sensor input to the hearing aid 100. In certain cases, the sensor(s) 150 can include one or more of: a physiological sensor such as a heart rate monitor, a motion sensor such as an inertial measurement unit (IMU), an acoustic sensor such as an additional or alternative microphone, an environmental sensor such as a humidity or moisture sensor, a strain sensor such as a strain gauge, etc. As noted herein, in various implementations distinct configurations of sensors can be implemented in distinct driver modules, which can be detected as described according to approaches herein.

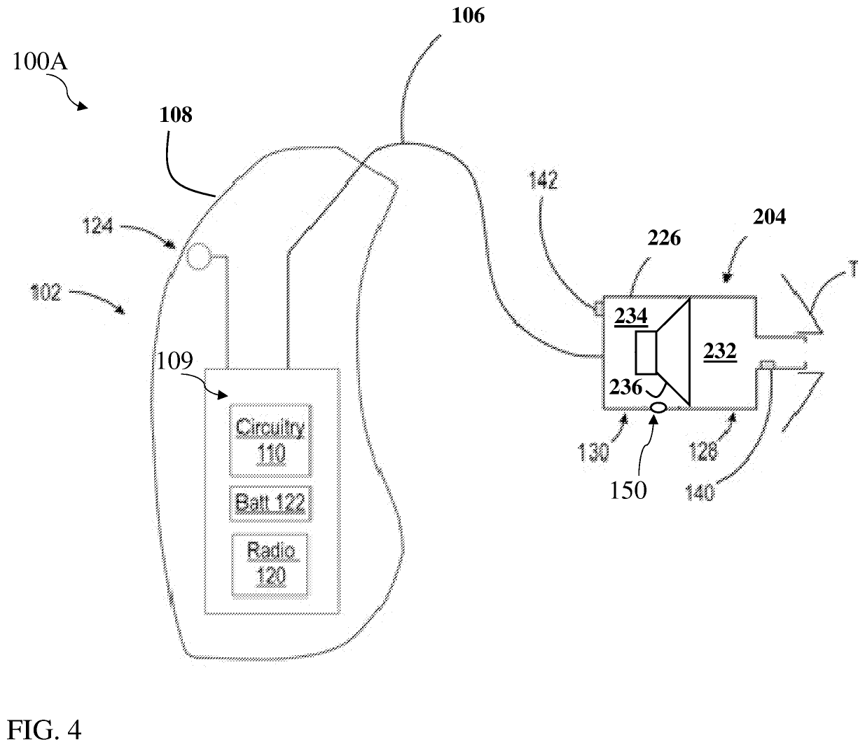

FIG. 4 shows another implementation of the hearing aid 100A with a distinct driver module, e.g., second driver module 204, connected to the BTE (control) portion 102. In various implementations, as noted herein, the BTE portion 102 is configured to interchangeably connect with the first driver module 104 and the second driver module 204. That is, the BTE portion 102 is configured to connect with only one of the first driver module 104 or the second driver module 204 at a time. In the example depiction in FIG. 4, the second driver module 204 differs from the first driver module 104 in one or more characteristics. In particular cases, each of the driver modules 104, 204 includes a receiver-in-canal (RIC) module. However, in other cases, driver modules 104, 204 may be mounted and/or sealed to the user's ear in distinct manners, e.g., such that the second driver module 204 is an open-ear, near-ear, or on-ear driver module. In certain examples, the second driver module 204 differs from the first driver module 104 in a characteristic such as driver type (e.g., size, displacement limit, acoustic chamber size/volume, etc.), sensor configuration (e.g., presence and/or capability of one or more sensors such as motion sensor, physiological sensor, microphones, etc.), physical housing size, etc. For example, driver modules 104, 204 can have distinct displacement limits, i.e., the driver(s) are capable of displacing distinct volumes of air when actuated by the electronics and as such provide distinct acoustic outputs. In some of these examples, second driver module 204 includes a second driver 236 that is larger than the driver 136 in first driver module 104. In certain of these cases, the second driver 236 is positioned in the second driver module 204 such that the front cavity 232 is smaller than the front cavity 132 in the first driver module 104, and/or the rear cavity 234 is smaller than the rear cavity 134 in the first driver module 104. In additional or alternative implementations, RIC housing 226 in the second driver module 204 is larger than RIC housing 136 in first driver module 104. Various other distinctions between driver modules 104, 204 are possible, e.g., distinctions between types of sensors 150 and/or microphones 140, 142 at distinct modules 104. Further, a plurality of distinct driver modules can be compatible with the control module (BTE portion) 102 and interconnect 106. For example, a number of earpieces may be connected to the BTE portion 102, such as earpieces accommodating: i) one receiver and zero microphones, ii) two receivers and zero microphones, iii) two receivers and one microphone, iv) one microphone and zero receivers, v) one receiver and one microphone positioned for, e.g., preservation of directional cue and/or suppressing occlusion, vi) one receiver and two microphones positioned for preservation of directional cute and/or suppressing occlusion, etc. While the use of two microphones can be beneficial in suppressing occlusion, it is understood that two-microphone configurations can also be beneficially deployed in noise cancelation, don/doff detection, etc.

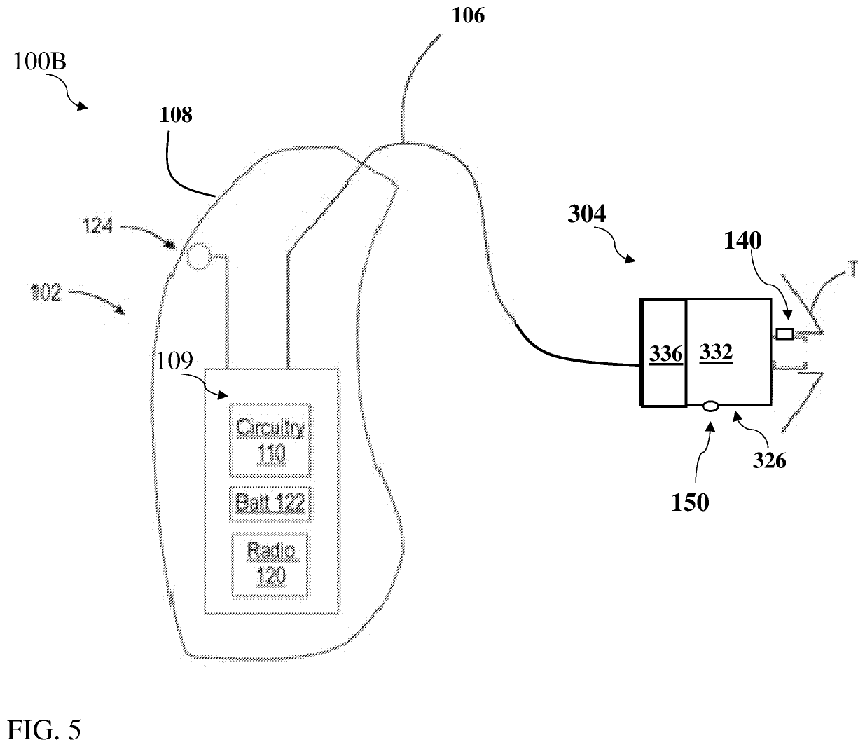

In various implementations, the distinct driver modules (e.g., modules 104, 204, etc.) can be differentiated in terms of their distinct frequency responses. For example, distinct driver types will result in distinct frequency responses that are detectable by the electronics 109 in the BTE portion 102. In particular examples, a balanced armature (BA) driver will provide a distinct frequency response than a moving coil driver, and that frequency response is detected by the electronics 109 in BTE portion 102. In further implementations, such as where the driver module includes a BA driver (e.g., in FIG. 5), a rear cavity (e.g., rear cavity 134, FIGS. 2, 4) is not necessary or is significantly reduced in size relative to a moving coil.

In still further implementations, as noted herein, the first driver module 104 can include a moving coil driver (e.g., driver 136), and in particular cases, is capable of providing ANR functionality, e.g., using feedback and/or feedforward microphones 140, 142. In certain of these cases, the first driver module 104 enables full bandwidth audio output. In some of these examples, the second driver module 204 differs in at least one characteristic from the first driver module 104, and for example, includes a balanced armature (BA) driver. However, it is understood that distinct driver types (e.g., moving coil v. BA) can be combined with distinct additional capabilities such as sensor(s) 150, feedback and/or feedforward microphones 140, 142, and/or ANR functionality. For example, FIG. 5 shows another implementation of a hearing aid 100B including a third driver module 304 having a housing 326 (e.g., RIC housing) and a BA driver 336. The housing 326 defines an acoustic chamber 332 in front of the BA driver 336. In this example implementation, one or more sensors 150 and/or microphones 140 are located on the third driver module 304 having a BA driver 336. FIG. 5 is merely one example of a combination of driver module features that are possible according to various implementations.

As noted herein, in contrast to conventional approaches, the electronics 109 in the BTE portion 102 are configured to measure a physical property of a connected one of the first driver module 104 or the second driver module 204 to determine which of those modules 104, 204 is connected to the BTE portion 102. In certain implementations, in response to determining which module (e.g., first driver module 104, second driver module 204, or additional driver module) is connected to the BTE portion 102, the electronics 109 adjust one or more settings at the hearing aid. In certain cases, the settings relate to processing the audio signal to the connected driver module. Further, settings can relate to audio tuning, adjustments in the types of signal processing algorithms run at the hearing aid, adjustments in which signal processing algorithms are run at the hearing aid, and/or adjustments in audio functionality at the hearing aid. For example, electronics 109 can adjust at least one of volume output or frequency of an audio signal to the driver module based on detecting the characteristic(s) of the driver module. In a particular case, electronics 109 increases a low frequency band for an audio signal in response to detecting a larger driver in the connected (first, second, etc.) driver module, and/or increases a high frequency band for an audio signal in response to detecting a smaller driver in the connected (first, second, etc.) driver module. Further, electronics 109 can adjust (e.g., enable or disable) ANR functionality in circuitry 110 based on detecting the characteristic(s) of the driver module, e.g., detecting feedback and/or feedforward microphone connections. For example, portions of circuitry 110 engaged in receiving and processing inputs from sensors such as feedback microphone 140 and a feedforward microphone 142 will differ significantly from the portions of circuitry 110 engaged in providing a processed audio signal without consideration for microphone inputs from microphones 140, 142. In certain examples, the driver modules differ in wiring characteristics, e.g., the first driver module 104 has distinct wiring from the second driver module 204, which the BTE portion 102 detects to differentiate between driver modules.

In still further implementations, the distinct driver modules (e.g., modules 104, 204, etc.) can be differentiated in terms of their signal processing, for example, by a DSP (processor 112) response to a change in feedback loop between modules. In one example, the moving coil driver in module 204 (FIG. 4) will provide a distinct feedback response to the processor 112 (e.g., DSP) when compared the BA driver in module 304 (FIG. 5). In certain examples, the processor 112 is configured to send a test signal (e.g., a test sound such as a chime) to the driver (e.g., moving coil driver or BA driver) and determine a characteristics of the module based on a feedback response from one or more sensors. In certain cases, the test signal is sent in response to detecting connection of the driver module, e.g., via interconnect 106. In some examples, the feedback loop response at the processor 112 from the second driver module 204 will be distinct from the feedback loop response at the processor 112 from the third driver module 304, e.g., due to characteristics of the acoustic response at feedback microphone(s) 140 and/or detected signals at the sensor(s) 150. These distinct feedback responses can be based on locations and/or position of the sensors (e.g., feedback microphone(s) 140, additional sensors 150), the size of the acoustic cavities (e.g., cavity 232 as compared with cavity 332), and/or characteristics of the driver, among other factors. In any case, the processor 112 (e.g., DSP) can be configured to detect distinct feedback responses from one or more sensors (including, for example, microphones) at distinct driver modules.

In still further implementations, in response to determining which module (e.g., first driver module 104, second driver module 204, third driver module 304, or an additional driver module) is connected to the BTE portion 102, the electronics 109 adjust one or more settings or configurations for the audio device. For example, as noted herein, in response to determining which module 104, 204, 304 is connected to the BTE portion 102, the electronics 109 adjust one or more settings for processing the audio signal to the connected driver module. In additional cases, the electronics 109 adjust additional or alternative functionality of the audio device in response to determining which module is connected to the BTE portion 102. For example, in response to detecting a heart rate sensor in sensor(s) 150, electronics 109 initiates monitoring of a heartbeat, and/or in response to detecting a motion sensor in sensor(s) 150), electronics 109 logs or otherwise tracks motion data.

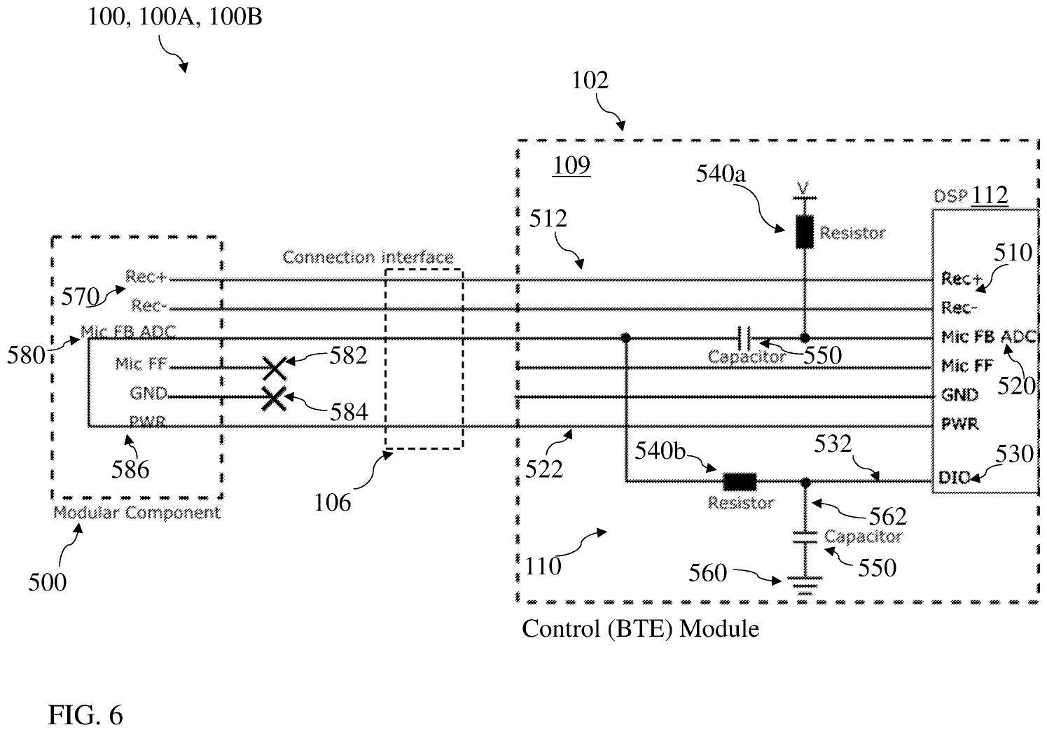

FIG. 6 illustrates an example wiring configuration between the BTE portion 102 and a module 500, which can include a driver module in certain implementations, e.g., first driver module 104, second driver module 204, or third driver module 304. Interconnect (or wiring) 106 is shown in some detail to illustrate wiring connections between the BTE portion 102 and the (e.g., driver) module 500. In certain implementations, electronics 109 such as first circuitry 110 are illustrated in BTE portion 102. In this example, receiver (REC) connections (+, −) 510 and corresponding wiring 512, a microphone feedback connector 520 and corresponding wiring 522, and a digital input/output (DIO) connector 530 and corresponding wiring 532 are illustrated in BTE portion 102. Further, resistor 540a connecting Mic FB 580 to V, and resistor 540b connecting Mic FB 580 to the DIO connections 530 are shown, along with capacitors 550 in the microphone feedback connector wiring 522 and the DIO to ground 560 wiring 562, respectively. In this non-limiting example, the module 500 includes a first set of wiring for coupling the driver (D) connections 570 (+/−), and microphone feedback 580, feedforward 582, ground 584, and power 586 connections.

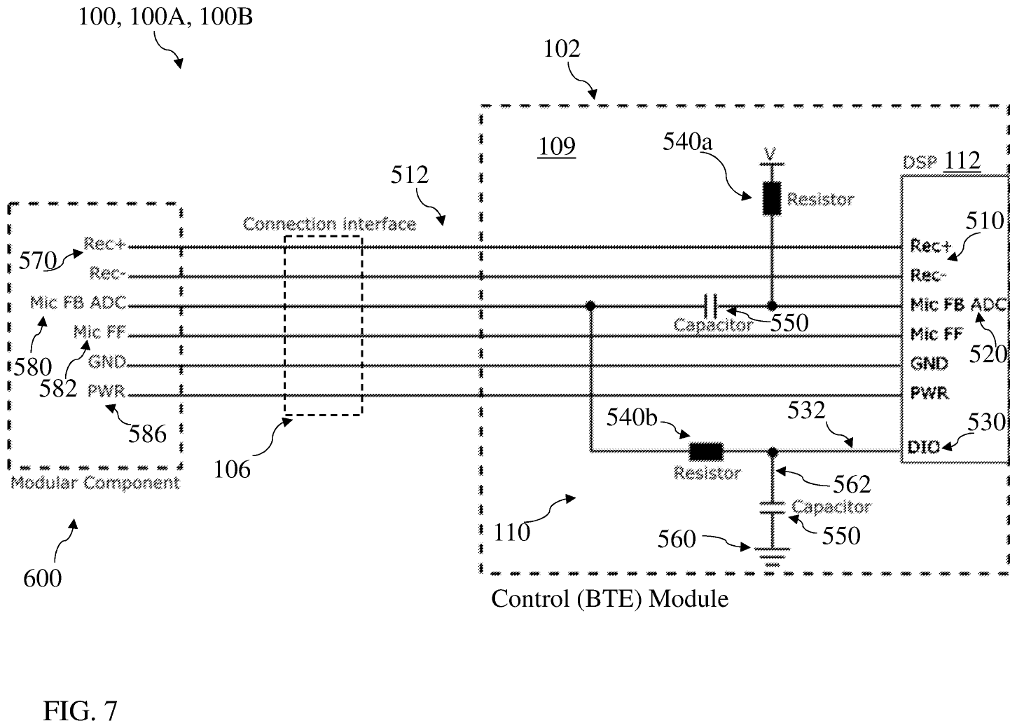

In one non-limiting example, the module 500 includes a balanced armature RIC module, which may in some cases have certain similar features to third driver module 304. In certain cases, the module 500 has six connections (pins). However, a seven pin, eight pin, nine pin, etc. connection configuration is also possible. Further, as noted herein, the module 500 can include any suitable driver capable of producing a desired acoustic output within the form factor, e.g., in-ear or on-ear configurations, and need not have a balanced armature driver. In the example depicted in FIG. 6, the BTE portion 102 is configured to detect the type of module 500 based on the wiring connection between the BTE portion 102 and module 500. For example, the electronics 109 detect the driver module 500 by measuring a physical property of the module 500 via wiring connections. In certain cases, the electronics 109 detect the module 500 based on at least one of a voltage response or a frequency response of the module 500 when connected. In FIG. 6, the driver module 500 is shown including two shorted connections (microphone feedback 580 to microphone power 586). In this case, the BTE portion 102 detects a first voltage across resistors 540 when connected with the module 500, e.g., based on the short between microphone feedback 580 and microphone power 586 connections. For example, the DIO 530 detects a first voltage across resistor 540b due to the shorted connection between microphone feedback 580 to microphone power 586. In contrast, in a distinct configuration illustrated in FIG. 7, a distinct module 600 (e.g., a distinct driver module) is illustrated showing connection between all connections on the module 600 and the connections on BTE portion 102. In this configuration, BTE portion 102 detects a second, distinct voltage across resistors 540 as compared with the connection to module 500. For example, the DIO 530 in BTE portion 102 detects a distinct voltage across resistor 540b than when the driver module 500 is connected to the BTE portion 102. In this case, the DIO 530 detects the voltage from the microphone feedback 580 as being approximately half the voltage of the microphone power 586.

In addition to detecting a distinction between connections such as shorted connections described with reference to module 500, in still further implementations, the BTE portion 102 detects distinct driver types between driver modules based on a resistance detected at resistor 540 between the receiver (REC) connections 510. For example, a first driver module with a first driver type (e.g., driver module 104) will have a first detectable voltage across the receiver connections 510 while a second driver module with a second driver type (e.g., a larger driver such as in driver module 204) will have a second, distinct detectable voltage (e.g., greater voltage drop) across the receiver connections 510. In such case, a distinction in driver type and/or size will be detectable using resistor 540 between the receiver connections 510.

In contrast to conventional approaches that rely on driver (or RIC) module identifiers such as those stored in memory, various implementations enable reliable, cost-effective identification of driver modules in audio devices such hearing aids. For example, various disclosed implementations enable detection of distinct driver modules (e.g., RIC modules) by a control module (e.g., BTE module) using a voltage response and/or a frequency response. The voltage and/or frequency response of the connection between the BTE and RIC modules is a function of the connection topology, and as such, does not require additional components that may be prone to failure or contribute to increased costs (e.g., memory). The various disclosed implementations can enhance device reliability as well as the user experience.

As noted herein the hearing aids 100 and other audio devices disclosed herein can include one or more circuit components for performing processes according to various implementations. In certain cases, the electronics 109 in hearing aid 100 includes a control circuit coupled with a processor and/or logic engine for adjusting a gain on one or more signals for producing an acoustic output. In some particular cases, a control circuit is contained in one or both earpieces in a headset, and receives commands from a logic engine for performing functions described herein. In additional cases, a logic engine is located remotely relative to earpieces in the hearing aid, e.g., in a connected smart devices such as a smart phone, smart watch, wearable smart device, etc., or in a cloud-based logic engine that is accessible via communications components at the hearing aid (not shown).

The controller(s) in the hearing aid 100 can execute instructions (e.g., software), including instructions stored in a memory or in a secondary storage device (e.g., a mass storage device). The controller(s) in the hearing aid 100 may be implemented as a chipset of chips that include separate and multiple analog and digital processors. The controllers in hearing aid 100 may provide, for example, for coordination of other components in the hearing aid 100, such as control of user interfaces, applications run by additional electronics in the hearing aid 100, and network communication by the hearing aid 100. The controller in the hearing aid 100 may manage communication with a user through a connected display and/or a conventional user input interface.

In various implementations, electronic components described as being “coupled” can be linked via conventional hard-wired and/or wireless means such that these electronic components can communicate data with one another. Additionally, sub-components within a given component can be considered to be linked via conventional pathways, which may not necessarily be illustrated.

The term “approximately” as used with respect to values herein can allot for a nominal variation from absolute values, e.g., of several percent or less. Unless expressly limited by its context, the term “signal” is used herein to indicate any of its ordinary meanings, including a state of a memory location (or set of memory locations) as expressed on a wire, bus, or other transmission medium. Unless expressly limited by its context, the term “generating” is used herein to indicate any of its ordinary meanings, such as computing or otherwise producing. Unless expressly limited by its context, the term “calculating” is used herein to indicate any of its ordinary meanings, such as computing, evaluating, smoothing, and/or selecting from a plurality of values. Unless expressly limited by its context, the term “obtaining” is used to indicate any of its ordinary meanings, such as calculating, deriving, receiving (e.g., from an external device), and/or retrieving (e.g., from an array of storage elements). Where the term “comprising” is used in the present description and claims, it does not exclude other elements or operations. The term “based on” (as in “A is based on B”) is used to indicate any of its ordinary meanings, including the cases (i) “based on at least” (e.g., “A is based on at least B”) and, if appropriate in the particular context, (ii) “equal to” (e.g., “A is equal to B”). Similarly, the term “in response to” is used to indicate any of its ordinary meanings, including “in response to at least.”

Unless indicated otherwise, any disclosure of an operation of an apparatus having a particular feature is also expressly intended to disclose a method having an analogous feature (and vice versa), and any disclosure of an operation of an apparatus according to a particular configuration is also expressly intended to disclose a method according to an analogous configuration (and vice versa). The term “configuration” may be used in reference to a method, apparatus, and/or system as indicated by its particular context. The terms “method,” “process,” “procedure,” and “technique” are used generically and interchangeably unless otherwise indicated by the particular context. The terms “apparatus” and “device” are also used generically and interchangeably unless otherwise indicated by the particular context. The terms “element” and “module” are typically used to indicate a portion of a greater configuration. Any incorporation by reference of a portion of a document shall also be understood to incorporate definitions of terms or variables that are referenced within the portion, where such definitions appear elsewhere in the document, as well as any figures referenced in the incorporated portion.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

Elements of figures are shown and described as discrete elements in a block diagram. These may be implemented as one or more of analog circuitry or digital circuitry. Alternatively, or additionally, they may be implemented with one or more microprocessors executing software instructions. The software instructions can include digital signal processing instructions. Operations may be performed by analog circuitry or by a microprocessor executing software that performs the equivalent of the analog operation. Signal lines may be implemented as discrete analog or digital signal lines, as a discrete digital signal line with appropriate signal processing that is able to process separate signals, and/or as elements of a wireless communication system.

When processes are represented or implied in the block diagram, the steps may be performed by one element or a plurality of elements. The steps may be performed together or at different times. The elements that perform the activities may be physically the same or proximate one another, or may be physically separate. One element may perform the actions of more than one block. Audio signals may be encoded or not, and may be transmitted in either digital or analog form. Conventional audio signal processing equipment and operations are in some cases omitted from the drawings.

Other embodiments not specifically described herein are also within the scope of the following claims. Elements of different implementations described herein may be combined to form other embodiments not specifically set forth above. Elements may be left out of the structures described herein without adversely affecting their operation. Furthermore, various separate elements may be combined into one or more individual elements to perform the functions described herein.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

I claim:

1. A hearing aid, comprising:
a control module comprising:
electronics for communicating with a first driver module and a second driver module; and
an interconnect configured to interchangeably connect with the first driver module and the second driver module,
wherein the electronics are configured to measure a physical property of a connected one of the first driver module or the second driver module to determine which of the first driver module or the second driver module is connected, and, in response to the determination, adjust one or more settings at the hearing aid.

2. The hearing aid of claim 1, wherein the first driver module and the second driver module differ in one or more characteristics.

3. The hearing aid of claim 2, wherein the one or more characteristics include distinct driver types.

4. The hearing aid of claim 1, wherein the electronics provide a processed audio signal to the connected one of the first driver module or the second driver module.

5. The hearing aid of claim 1, wherein the first driver module includes first wiring for coupling the first driver module to the interconnect and the second driver module includes second wiring for coupling the second driver module to the interconnect.

6. The hearing aid of claim 5, wherein the electronics are configured to measure a physical property of the connected one of the driver modules via the corresponding wiring.

7. The hearing aid of claim 1, wherein the electronics in the control module detect a first voltage when the first driver module is connected with the interconnect and a second voltage when the second driver module is connected with the interconnect.

8. The hearing aid of claim 1, wherein the first driver module and the second driver module are in-ear driver modules.

9. The hearing aid of claim 8, wherein the first driver module and the second driver module include receiver-in-canal (RIC) modules.

10. The hearing aid of claim 8, wherein the control module includes a behind-the-ear (BTE) module.

11. The hearing aid of claim 1, wherein when the second driver module is connected with the interconnect, at least a portion of wiring in the second driver module is shorted.

12. The hearing aid of claim 11, wherein when the second driver module is connected with the interconnect, at least one microphone wire is shorted to a microphone power wire.

13. The hearing aid of claim 1, wherein the first driver module includes a moving coil driver, wherein the first driver module is capable of providing acoustic noise reduction (ANR) functionality and enables full bandwidth audio output, and
wherein the second acoustic assembly include a balanced armature (BA) driver.

14. A hearing aid comprising:
a first receiver-in-canal (RIC) module comprising a first driver module;
a behind-the-ear (BTE) module comprising electronics for communicating with the first RIC module; and
an interconnect for connecting the first RIC module and the BTE module,
wherein the interconnect is configured to interchangeably connect with the first RIC module and a second RIC module having a second driver module, and
wherein the electronics are configured to measure a physical property of a connected one of the first RIC module or the second RIC module to determine which of the first RIC module or the second RIC module is connected, and, in response to the determination, adjust one or more settings at the hearing aid.

15. The hearing aid of claim 14, wherein the electronics measure at least one of a voltage response or a frequency response of the connected one of the first RIC module or the second RIC module to determine which of the first RIC module or the second RIC module is connected.

16. The hearing aid of claim 14, wherein the first RIC module is capable of providing acoustic noise reduction (ANR) functionality and enables full bandwidth audio output, and wherein the second RIC assembly include a balanced armature (BA) driver.

17. An acoustic assembly, comprising:
a first driver module;
a control module comprising electronics for communicating with the first driver module; and
an interconnect for connecting the first driver module and the control module,
wherein the interconnect is configured to interchangeably connect with the first driver module and a second driver module, wherein the first driver module and the second driver module differ in one or more characteristics, and
wherein the electronics are configured to measure a physical property of a connected one of the first driver module or the second driver module to determine which of the first driver module or the second driver module is connected, and, in response to the determination, adjust one or more settings at the hearing aid.

18. A hearing aid comprising the acoustic assembly of claim 17.

19. An automobile audio system comprising the acoustic assembly of claim 17.

20. A home audio system comprising the acoustic assembly of claim 17.
